(19) United States
(12) Patent Application Publication
(10) Pub. No.: US 2023/0351268 A1
(43) Pub. Date: Nov. 2, 2023

(54) INFORMATION PROCESSING DEVICE AND INFORMATION PROCESSING METHOD

(71) Applicant: Fujitsu Limited, Kawasaki-shi (JP)

(72) Inventor: Sho TAKEMORI, Yokohama (JP)

(73) Assignee: Fujitsu Limited, Kawasaki-shi (JP)

(21) Appl. No.: 18/102,770

(22) Filed: Jan. 30, 2023

(30) Foreign Application Priority Data
Apr. 27, 2022 (JP) 2022-072908

(51) Int. Cl. G06N 20/10

(52) U.S. Cl. CPC G06N 20/10

(57) ABSTRACT

A non-transitory computer-readable recording medium stores a program for causing a computer to execute a process, the process includes obtaining an estimated value of a risk aversion index for each of a plurality of candidate points in a search space based on a kernel function and an observation history including one or a plurality of observation points and an observed value of a random variable for each of the one or the plurality of observation points, obtaining a value of an acquisition function for each of the plurality of candidate points based on the estimated value of the risk aversion index, searching for a target point corresponding to a predetermined value of the acquisition function from among the plurality of candidate points based on the value of the acquisition function, and outputting a search result including the target point.

### CROSS-REFERENCE TO RELATED APPLICATION

This application is based upon and claims the benefit of priority of the prior Japanese Patent Application No. 2022-072908, filed on Apr. 27, 2022, the entire contents of which are incorporated herein by reference.

### FIELD

The present embodiment discussed herein is related to an information processing device and an information processing method.

### BACKGROUND

Bayesian optimization is a technique for optimizing an unknown function f, which may only be known through noisy observations, while repeating observations. Bayesian optimization has been applied to problems of optimizing the function f while obtaining a feedback.

Such problems include material design, drug discovery, recommendation systems, sensor placement for environmental monitoring, hyperparameter tuning for machine learning, automated machine learning (AutoML), and the like. The recommendation systems include systems for web advertising, website optimization, and the like.

In many Bayesian optimizations, a score a(x) for a point x in a search space is defined based on an observation history, and the point with the largest a(x) is selected as the next observation point. The a(x) is sometimes called acquisition function.

In relation to optimization, a method of optimizing conditional value-at-risk (CVaR) of a black-box function is known. Gaussian process optimization in bandit settings is also known. Spectral bandits for smooth graph functions are also known. Multi-period trading by convex optimization is also known.

Q. P. Nguyen et al., “Optimizing Conditional Value-At-Risk of Black-Box Functions”, NeurIPS 2021, 2021., N. Srinivas et al., “Gaussian Process Optimization in the Bandit Setting: No Regret and Experimental Design”, ICML 2010, 2010., Valko et al., “Spectral Bandits for Smooth Graph Functions”, ICML 2014, 2014. and Boyd et al., “Multi-period Trading via Convex Optimization”, Foundations and Trends in Optimization, 2017, are disclosed as related art.

### SUMMARY

According to an aspect of the embodiment, a non-transitory computer-readable recording medium stores a program for causing a computer to execute a process, the process includes obtaining an estimated value of a risk aversion index for each of a plurality of candidate points in a search space based on a kernel function and an observation history including one or a plurality of observation points and an observed value of a random variable for each of the one or the plurality of observation points, obtaining a value of an acquisition function for each of the plurality of candidate points based on the estimated value of the risk aversion index, searching for a target point corresponding to a predetermined value of the acquisition function from among the plurality of candidate points based on the value of the acquisition function, and outputting a search result including the target point.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a functional configuration of an information processing device according to an embodiment;

FIG. 2 is a flowchart of search processing performed by the information processing device;

FIG. 3 is a diagram illustrating a functional configuration of a search device;

FIG. 4 is a diagram illustrating a calculation equation of CVaR(x, t);

FIG. 5 is a flowchart of first search processing;

FIG. 6 is a diagram illustrating CVaR and UCB in round t;

FIG. 7 is a diagram illustrating CVaR and UCB in round t+1;

FIG. 8 is a diagram illustrating CVaR and UCB in round t+2;

FIG. 9A is a flowchart (part 1) of second search processing;

FIG. 9B is a flowchart (part 2) of the second search processing; and

FIG. 10 is a diagram illustrating a hardware configuration of the information processing device.

### DESCRIPTION OF EMBODIMENT

In normal Bayesian optimization such as Gaussian process upper confidence bound (GP-UCB) or Gaussian process expected improvement (GP-EI), a point x that maximizes an expected value E[f(x)] of the function f(x) is searched for. However, for some problems, an index other than the expected value may be important, such as an index regarding robustness or risk.

For example, in mean-variance optimization, the point x at which variance V[f(x)] of f(x) is small and the expected value E[f(x)] is large is searched for. However, the variance similarly treats a case where a value of a random variable representing f(x) is larger than the expected value and a case where the value is smaller than the expected value. Therefore, in the case of searching for the point x at which the value of the random variable is large, characteristics of a distribution may not be appropriately captured only with the expected value and the variance.

Therefore, CVaR is sometimes used as an index in Bayesian optimization. CVaR represents an expected value of a random variable conditioned by an adverse event that occurs with a certain probability or less. For example, CVaR is used to evaluate investment strategies in finance. In this case, CVaR represents an average return in adverse events such as financial crises that occur with a low probability.

However, simply searching for the point x that optimizes CVaR does not necessarily lead to efficient searching.

Note that this problem occurs not only in the search processing for optimizing CVaR but also in search processing for optimizing various risk aversion indices. The risk aversion indices mean indices for avoiding a risk.

Hereinafter, an embodiment will be described in detail with reference to the drawings.

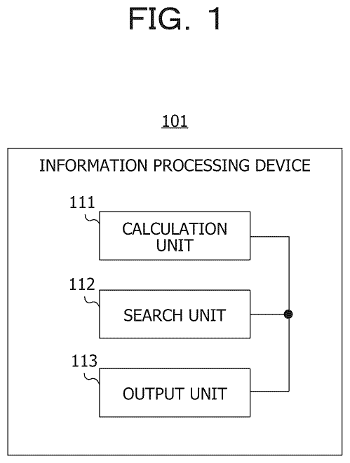

FIG. 1 illustrates a functional configuration example of an information processing device (computer) according to the embodiment. An information processing device 101 in FIG. 1 includes a calculation unit 111, a search unit 112, and an output unit 113.

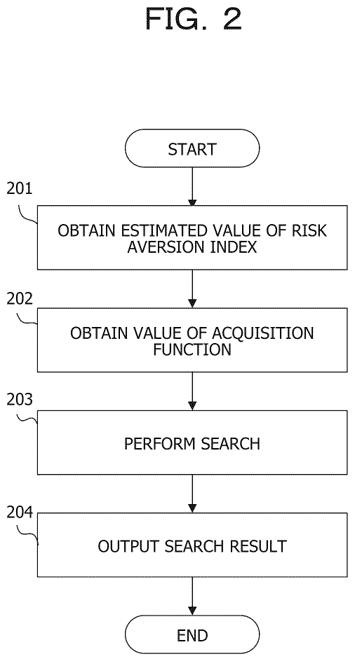

FIG. 2 is a flowchart illustrating an example of search processing performed by the information processing device 101 in FIG. 1. First, the calculation unit 111 obtains an estimated value of a risk aversion index for each of a plurality of candidate points in a search space based on a kernel function and an observation history that includes one or a plurality of observation points and an observed value of a random variable for each of the observation points (step 201). Next, the calculation unit 111 obtains a value of an acquisition function for each of the plurality of candidate points based on the estimated value of the risk aversion index (step 202).

The search unit 112 searches for a target point corresponding to a predetermined value of the acquisition function from among the plurality of candidate points based on the value of the acquisition function (step 203). The output unit 113 outputs a search result including the target point (step 204).

According to the information processing device 101 in FIG. 1, the efficiency of the search processing based on the risk aversion index may be improved.

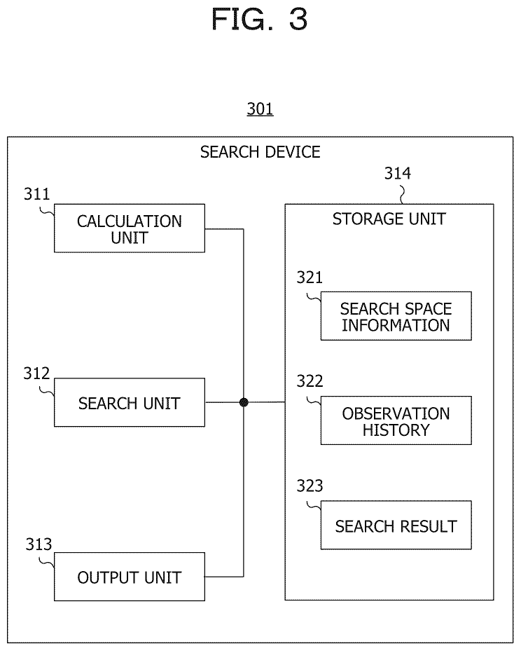

FIG. 3 illustrates a functional configuration example of a search device corresponding to a specific example of the information processing device 101 in FIG. 1. A search device 301 in FIG. 3 includes a calculation unit 311, a search unit 312, an output unit 313, and a storage unit 314, and performs first search processing or second search processing. The first search processing and the second search processing are search processing based on Bayesian optimization.

In the first search processing and the second search processing, the search device 301 searches for the target point corresponding to the predetermined value of the acquisition function including the risk aversion index. The predetermined value of the acquisition function may be a maximum value or a minimum value.

The calculation unit 311, the search unit 312, and the output unit 313 respectively correspond to the calculation unit 111, the search unit 112, and the output unit 113 in FIG. 1.

The storage unit 314 stores search space information 321 and an observation history 322. The search space information 321 indicates a search space W. The observation history 322 includes one or a plurality of observation points and the observed value of the random variable for each of the observation points.

The calculation unit 311 calculates the estimated value of the risk aversion index for each of a plurality of points in the search space W using the observation history 322, and calculates the value of the acquisition function using the estimated value of the risk aversion index. Points in the search space W correspond to the candidate points.

The search unit 312 searches for the target point based on the calculated acquisition function value, generates a search result 323 including the searched target point, and stores the search result in the storage unit 314. The output unit 113 outputs the search result 323.

CVaR is used as an example of the risk aversion index. CVaR(F) for a random variable X according to a cumulative distribution function F is expressed by, for example, the following equation.

CVaR(F)=E_{X˜F}[X|X≤F⁻¹(α)] (1)

α is a real number from 0 to 1, both inclusive, and represents a risk level. F⁻¹(α) represents an inverse function of F(α). X˜F represent that X follows F. Approximately, when an ascending sequence of samples of X generated from F is X1, X2, . . . , Xn, the right side of the equation (1) corresponds to an average value of X1, X2, . . . , X[nα]. Note that [nα] represents the largest integer equal to or less than nα.

A usual Bayesian optimization model assumes that the function f is modeled by a Gaussian process and a reproducing kernel Hilbert space. In this model, in a case where points x and x′ are close, f(x) and f(x′) are also close, and so the amount of calculation for the search processing is reduced.

In contrast, the search device 301 models, instead of the function f, a probability distribution ρ(x) that depends on x using kernel mean embedding (KME). A random variable y representing f(x) follows the probability distribution ρ(x).

KME is a technique for embedding ρ(x) in the reproducing kernel Hilbert space by vectorizing ρ(x). By vectorizing ρ(x), it is possible to calculate a distance between two probability distributions, a norm of joint probability distributions, and the like. Conditional mean embedding (CME) is a technique for vectorizing conditional probabilities and may be said to be a special example of KME.

The kernel function k(x, x′) used in KME represents a similarity between x and x′. As the kernel function k, a radial basis function (RBF) kernel, a Matern kernel, or the like may be used. x and x′ may be scalars, vectors, or graphs. For example, in a case where graphs representing chemical formulas of compounds are used as x and x′, k(x, x′) represents the similarity between the two compounds.

First, the first search processing will be described. The search unit 312 selects a point xₜ in the search space W for rounds t=1, 2, . . . , T, and acquires an observed value yₜ of the random variable y that follows a probability distribution ρ(xₜ). t is a control variable representing a time step, and T is an integer equal to or larger than 2 representing a total number of rounds. An observation history H generated in the round t contains (x₁, y₁), . . . , (xₜ, yₜ). The observation history H corresponds to the observation history 322.

In round t+1, the calculation unit 311 calculates an estimated value CVaR(x, t) of CVaR for the point x in the search space W, using the observation history H generated in the round t and the kernel function k.

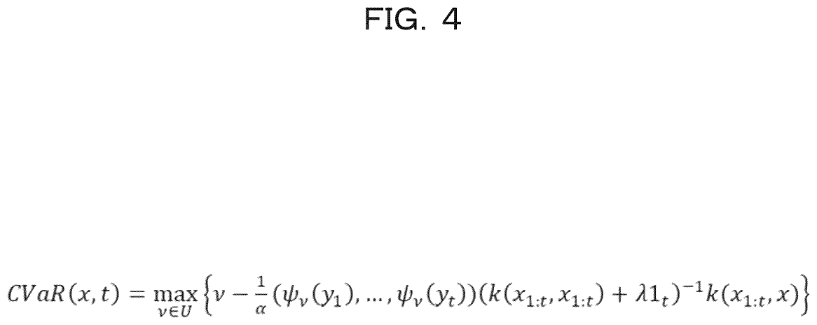

FIG. 4 illustrates an example of a calculation equation for CVaR(x, t). A set ∪ is defined by ∪={a, b, y₁, . . . , yₜ}, assuming that all elements of a support of the probability distribution ρ(x) are contained in an interval [a, b]. v represents any element of ∪. The right side of the calculation equation in FIG. 4 represents the maximum value of values in { } for each v included in ∪.

α represents the risk level. λ is a positive real number. ψᵥ(y) represents max(v−y, 0) and max(p, q) represents the maximum value of p and q. (ψᵥ(y₁), . . . , ψᵥ(yₜ)) represents a t-dimensional row vector whose j-th element is ψᵥ(yⱼ).

k(x_{1:t}, x_{1:t}) represents a t×t matrix whose element in row i and column j is k(xᵢ, xⱼ). 1ₜ represents a t×t identity matrix. (k(x_{1:t}, x_{1:t})+λ1ₜ)⁻¹ represents an inverse matrix of k(x_{1:t}, x_{1:t})+λ1ₜ. k(x_{1:t}, x) represents a t-dimensional column vector whose i-th element is k(xᵢ, x).

In the round t+1, the calculation unit 311 calculates a value UCB(x, t) of an acquisition function UCB for the point x according to the following equation, using CVaR(x, t) in FIG. 4.

UCB(x,t)=CVaR(x,t)+(β/α)σₜ(x) (2)

β is a positive real number. σₜ(x) represents prediction uncertainty for the random variable y. As σₜ(x), for example, standard deviation in the equation (2) of N. Srinivas et al., “Gaussian Process Optimization in the Bandit Setting: No Regret and Experimental Design”, ICML 2010, 2010 may be used.

When t is 1, the search unit 312 randomly selects an observation point x₁ from the search space W and observes y₁. When t is 2 or more, the search unit 312 selects the point x that maximizes UCB(x, t−1) among the points x in the search space W as the next observation point xₜ, and observes yₜ. By selecting the point x that maximizes UCB(x, t−1), a point with a large estimated value of CVaR may be selected and a point with high uncertainty may be selected. Selecting the point with high uncertainty facilitates the search.

The search device 301 may obtain optimal solutions to various optimization problems by performing the first search processing or the second search processing. For example, in a problem of optimizing a hyperparameter of a machine learning model, the hyperparameter may be used as x and an accuracy rate of the machine learning model for known input data may be used as y.

As the machine learning model, a neural network, a decision tree, logistic regression, support vector machine, or the like is used. In the case of a neural network, the hyperparameter may be the number of units, the number of layers, or a training rate.

Applications of the optimization problems include finance, medical care, healthcare, drug discovery, recruitment, fraud detection, material design, recommendation systems, sensor placement, and the like. The fraud detection includes detection of fraudulent use of credit cards, fraudulent insurance claims, and the like.

Finance includes stock trading. For example, in the case of stock trading in Boyd et al., “Multi-period Trading via Convex Optimization”, Foundations and Trends in Optimization, 2017, a three-dimensional vector whose elements are a risk aversion variable, a trade aversion variable, and a holding aversion variable may be used as x, and a daily return obtained from stock trading may be used as y. The higher the risk aversion variable, the more likely traders will avoid volatile stocks, the higher the trade aversion variable, the less likely the traders will trade, and the higher the holding aversion variable, the less likely the traders will perform short sell.

Medical care includes cancer stage classification. In the case of classifying cancer stages using a classifier called extreme gradient boosting (XGboost), a multidimensional vector with multiple hyperparameters as elements may be used as x, and F values and the like in verification data may be used as y. The hyperparameters may be a training rate, a maximum value of depth of a decision tree, a regularization factor, a ratio of the number of features randomly extracted when generating the decision tree, and the like. XGboost is also used in applications other than medical care.

In drug discovery, compounds useful as drugs may be searched for by repeating simulations or experiments. In this case, a graph representing a chemical formula of a compound may be used as x, and an effect of a drug observed by simulation or experiment may be used as y. The effects of drugs are represented by binding free energies, dissociation constants, and the like.

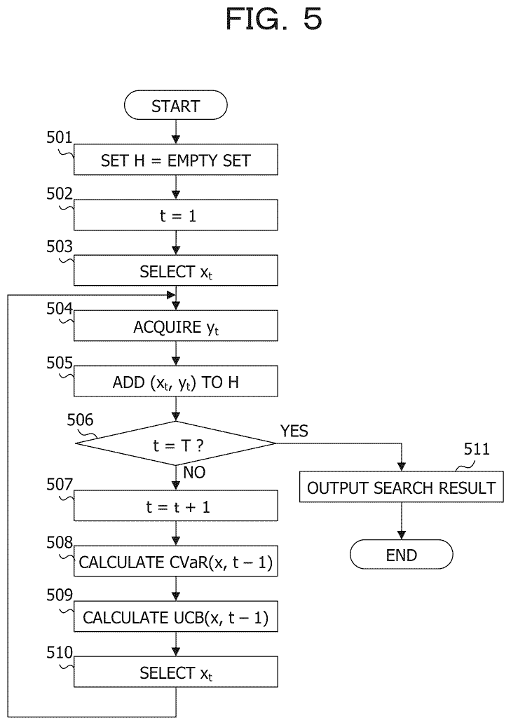

FIG. 5 is a flowchart illustrating an example of the first search processing. First, the search unit 312 sets an empty set as the observation history H (step 501), and sets t to 1 (step 502).

Next, the search unit 312 randomly selects the observation point xₜ from the search space W (step 503), and acquires the observed value yₜ for xₜ (step 504). The search unit 312 then updates H by adding (xₜ, yₜ) to H (step 505).

Next, the search unit 312 then compares t with T (step 506). In a case where t is less than T (step 506, NO), the search unit 312 increments t by 1 (step 507).

Next, the calculation unit 311 calculates CVaR(x, t−1) for each point x in the search space W using the calculation equation in FIG. 4 (step 508), and calculates UCB(x, t−1) using the equation (2) (step 509).

Next, the search unit 312 selects the point x that maximizes UCB(x, t−1) as the next observation point xₜ (step 510), and repeats the processing from step 504 onwards. The search unit 312 may identify the point x that maximizes UCB(x, t−1) by random search or exhaustive search, for example.

In a case where t=T (step 506, YES), the search unit 312 generates the search result 323, and the output unit 113 outputs the search result 323 (step 511). The search result 323 may include H={(x₁, y₁), . . . , (x_{T}, y_{T})} or only (x_{T}, y_{T}). x_{T} corresponds to the target point.

In step 506, the search unit 312 may determine whether or not to terminate the search, using other termination conditions.

The observation point xₜ selected in step 510 in the round t is an example of a first observation point, and H updated in step 505 is an example of an updated observation history. The observation point xₜ₊₁ selected in step 510 in the round t+1 is an example of a second observation point.

In the case of optimizing the hyperparameters of the machine learning model, the search unit 312 may construct the machine learning model, using the hyperparameters indicated by x_{T} in the search result 323. In this case, the search unit 312 may generate a trained machine learning model by inputting training data into the constructed machine learning model and causing the machine learning model to perform machine learning.

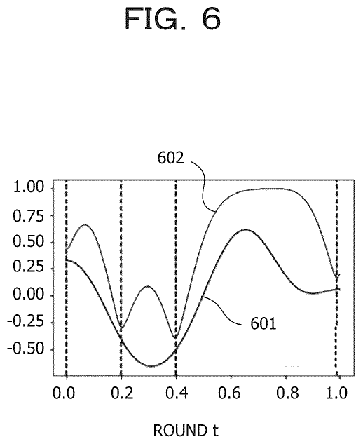

FIG. 6 illustrates an example of CVaR and UCB in the round t. The horizontal axis represents the one-dimensional search space W, and the vertical axis represents CVaR and UCB. The broken line represents the selected observation points x included in the observation history H. Curve 601 represents a true value of CVaR for each point x in the search space W, and curve 602 represents the value of UCB(x, t−1) for each point x in the search space W.

In this case, the selected observation points x are four: 0.0, 0.2, 0.4, and 1.0. As the next observation point xₜ, 0.77 corresponding to the maximum value of UCB(x, t−1) is selected and the observed value yₜ for 0.77 is obtained. Then (xₜ, yₜ) is added to H.

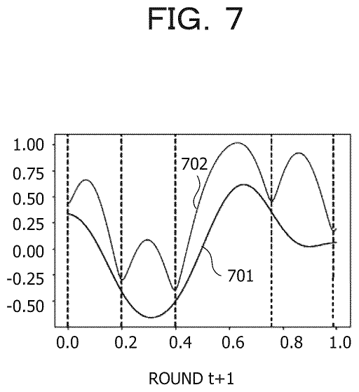

FIG. 7 illustrates an example of CVaR and UCB in the round t+1. Curve 701 represents the true value of CVaR and curve 702 represents the value of UCB(x, t). Although the true value of CVaR is not observed, by using the equation (2), observation reduces the uncertainty in the neighborhood of x=0.77 and UCB(x, t) is approaching the true value of CVaR.

In this case, 0.63 corresponding to the maximum value of UCB(x, t) is selected as the next observation point xₜ₊₁, and the observed value yₜ₊₁ for 0.63 is obtained. Then (xₜ₊₁, yₜ₊₁) is added to H.

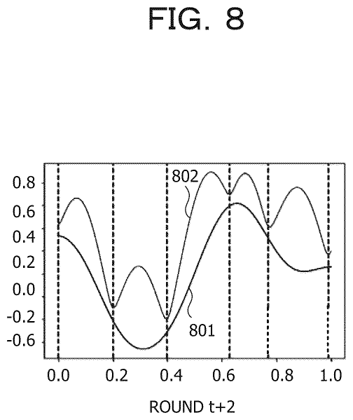

FIG. 8 illustrates an example of CVaR and UCB in the round t+2. Curve 801 represents the true value of CVaR and curve 802 represents the value of UCB(x, t+1). Observation reduces the uncertainty in the neighborhood of x=0.63 and UCB(x, t+1) is approaching the true value of CVaR.

According to the first search processing, the estimated value of CVaR in the neighborhood of the searched point x is improved by applying the kernel function k to the updated observation history H while updating the observation history H. Therefore, the search efficiency is improved. For example, the search is suppressed in the neighborhood of the point x where CVaR is estimated to be small, whereas the search is promoted in the neighborhood of the point x where CVaR is estimated to be large.

In normal Bayesian optimization, which models the function f, CVaR may be optimized only for special problems. In contrast, Bayesian optimization using KME models the probability distributions, allowing CVaR to be optimized for more general problems.

As the risk aversion index in the first search processing, an index MV(ρ) including the expected value and variance of the random variable y may be used instead of CVaR. MV(ρ) is represented by, for example, the following equation.

MV(ρ)=E[ρ]−γV[ρ]

=E_{y˜ρ}[y]−γE_{y˜ρ}[y²]γ(E_{y˜ρ}[y])² (3)

γ is a positive real number. E[ρ] represents the expected value of ρ(x) and V[ρ] represents the variance of ρ(x). E_{y˜ρ}[y] represents the expected value of y, and E_{y˜ρ}[y²] represents the expected value of y². y˜ρ represents that y follows ρ. By performing Bayesian optimization using MV(ρ), it is possible to search for the point x with a large expected value E[ρ] and a small variance V[ρ].

In this case, in the round t+1, the calculation unit 311 calculates an estimated value m(x, t, r) (r=1, 2) of E_{y˜ρ}[y^{r}] for the point x in the search space W by the following equation, using the observation history H generated in the round t and the kernel function k.

m(x,t,r)=(y₁^{r}, . . . ,yₜ^{r})(k(x_{1:t},x_{1:t})+λ1ₜ)⁻¹k(x_{1:t},x) (4)

(y₁^{r}, . . . , yₜ^{r}) represents a t-dimensional row vector whose j-th element is yⱼ^{r}. (k(x_{1:t}, x_{1:t})+λ1ₜ)⁻¹ and k(x_{1:t}, x) are similar to those in the calculation equation in FIG. 4.

In the round t+1, the calculation unit 311 calculates a value UCB_{MV}(x, t) of an acquisition function UCB_{MV} for the point x by the following equation, using m(x, t, r) in the equation (4).

UCB_{MV}(x,t)=m(x,t,1)−γm(x,t,2)+γ(m(x,t,1))²+β1σₜ(x)+β2(σₜ(x))² (5)

β1 and β2 are positive real numbers. σₜ(x) is similar to that in the equation (2).

In the case of using the acquisition function UCB_{MV} in the first search processing, the calculation unit 311 calculates m(x, t−1, r) by the equation (4) in step 508 in FIG. 5, and calculates UCB_{MV}(x, t−1) by the equation (5) in step 509. Then, in step 510, the search unit 312 selects the point x that maximizes UCB_{MV}(x, t−1) as the next observation point xₜ. Therefore, the index MV(ρ) may be optimized instead of CVaR.

Next, the second search processing will be described. The search space W in the second search processing is a finite set. In the second search processing, points x that do not need to be searched for is excluded from the search space W based on the value UCB(x, t) of the acquisition function UCB, and the next observation point xₜ₊₁ is selected from the remaining points x.

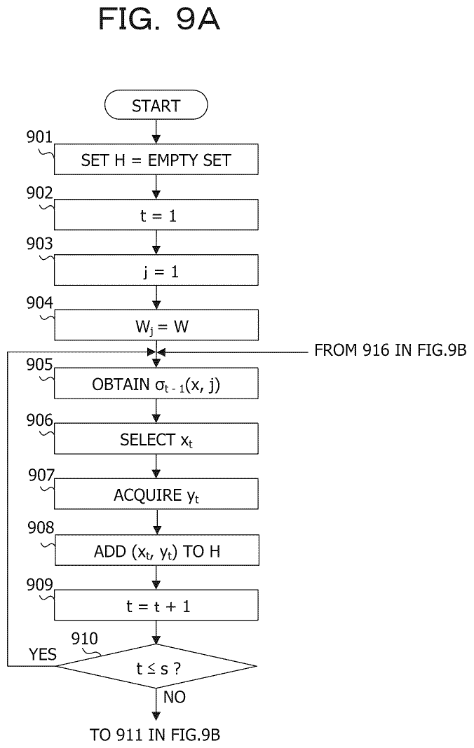

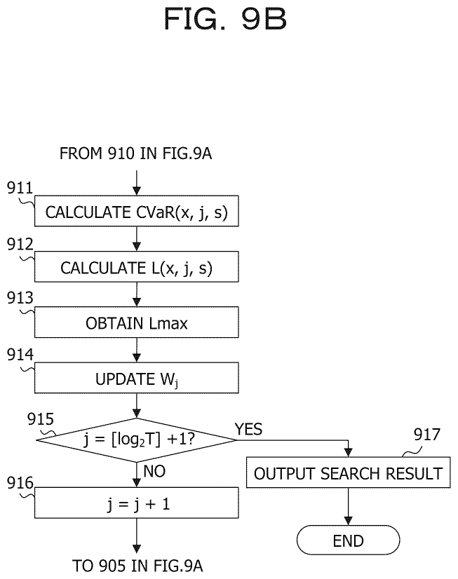

FIGS. 9A and 9B are flowcharts illustrating an example of the second search processing. First, the search unit 312 sets an empty set as the observation history H (step 901), and sets t to 1 (step 902). Then, the search unit 312 sets j to 1 (step 903), and sets the search space Wⱼ to W (step 904).

Next, the search unit 312 obtains at σₜ₋₁(x, j), using t(j)=2^{j-1} (step 905). In step 905, the search unit 312 defines the uncertainty at σₜ₋₁(X) at each point x in Wⱼ using only xₜ₍ⱼ₎, . . . , xₜ₋₁ of x₁, . . . , xₜ₋₁ included in H, and sets at σₜ₋₁(x, j) to the defined at σₜ₋₁(x).

Next, the search unit 312 selects the point x that maximizes at σₜ₋₁(x, j) from Wⱼ as the next observation point xₜ (step 906), and acquires the observed value yₜ for xₜ (step 907). The search unit 312 then updates H by adding (xₜ, yₜ) to H (step 908).

Next, the search unit 312 increments t by 1 (step 909) and compares t with s (step 910). s represents the minimum value of t(j+1)−1 and T. t(j+1)=2^{j}. In a case where t is equal to or less than s (step 910, YES), the search unit 312 repeats the processing of step 905 onwards.

In a case where t is larger than s (step 910, NO), the calculation unit 311 calculates the estimated value CVaR(x, j, s) of CVaR for each point x in Wⱼ using the following equation (step 911).

$$CVaR ( x , j , s ) = {max}_{v ∈ U} \{ v - \frac{1}{α} ( {ψ}_{v} ( {y}_{t ( j )} ) , … , {ψ}_{v} ( {y}_{s} ) ) {( k ( {x}_{t ( j ) : s} , {x}_{t ( j ) : s} ) + λ {1}_{s - t ( j ) + 1} )}^{- 1} k ( {x}_{t ( j ) : s} , x ) \} \qquad ( 6 )$$

where ∪={a, b, yₜ₍ⱼ₎, . . . , yₛ}. The right side of the equation (6) represents the estimated value of CVaR, which is calculated using only (xₜ₍ⱼ₎, yₜ₍ⱼ₎), . . . , (xₛ, yₛ) of (x₁, y₁), (xₜ₋₁, yₜ₋₁) included in H.

Next, the calculation unit 311 calculates a value L(x, j, s) of an acquisition function L for each point x in Wⱼ using the following equation (step 912).

L(x,j,s)=CVaR(x,j,s)−(β(δ)/α)σₛ(x,j) (7)

β(δ)=λ^{1/2}+(log(1/δ))^{1/2} (8)

λ and δ are positive real numbers. Next, the search unit 312 obtains a maximum value L max of L(x, j, s) for each point x in Wⱼ (step 913). Then, the search unit 312 updates Wⱼ by excluding the points x that satisfy the following equation from Wⱼ to generate the search space Wⱼ₊₁ including the remaining points x (step 914).

CVaR(x,j,s)+(β(δ)/α)σₛ(x,j)<L max (9)

Next, the search unit 312 compares j with [log₂T]+1 (step 915). [log₂T] represents the largest integer equal to or less than log₂T. In a case where j is less than [log₂T]+1 (step 915, NO), the search unit 312 increments j by 1 (step 916) and repeats the processing in step 905 onwards using Wⱼ₊₁ generated in step 914.

In a case where j=[log₂T]+1 (step 915, YES), the search unit 312 generates the search result 323, and the output unit 113 outputs the search result 323 (step 917). The search result 323 may include H={(x₁, y₁), (x_{T}, y_{T})} or only (x_{T}, y_{T}).

In step 915, the search unit 312 may determine whether or not to terminate the search, using other termination conditions.

The search space Wⱼ₊₁ generated in step 914 is an example of a first search space, and the search space Wⱼ₊₂ generated next to Wⱼ₊₁ is an example of a second search space.

According to the second search processing, the estimated value of CVaR in the neighborhood of the searched point x is improved by applying the kernel function k to the updated observation history H, and thus the search efficiency is improved, similarly to the first search processing. Moreover, it becomes possible to obtain the optimum solution faster than in the first search processing by narrowing down the search target while updating the search space Wⱼ.

The configuration of the information processing device 101 of FIG. 1 is merely an example, and some configuration elements may be omitted or modified depending on the use or conditions of the information processing device 101. The configuration of the search device 301 in FIG. 3 is merely an example, and some configuration elements may be omitted or modified depending on the use or conditions of the search device 301.

The flowcharts in FIGS. 2, 5, 9A, and 9B are merely examples, and some processing may be omitted or modified depending on the configuration or conditions of the information processing device 101 or the search device 301.

The calculation equation in FIG. 4 is only an example, and the search device 301 may calculate CVaR(x, t) using another calculation equation. The changes in CVaR and UCB illustrated in FIGS. 6 to 8 are only examples, and CVaR and UCB change depending on the problem to which the search processing is applied.

The equations (1) to (9) are merely examples and the search device 301 may perform the search processing using other calculation equations.

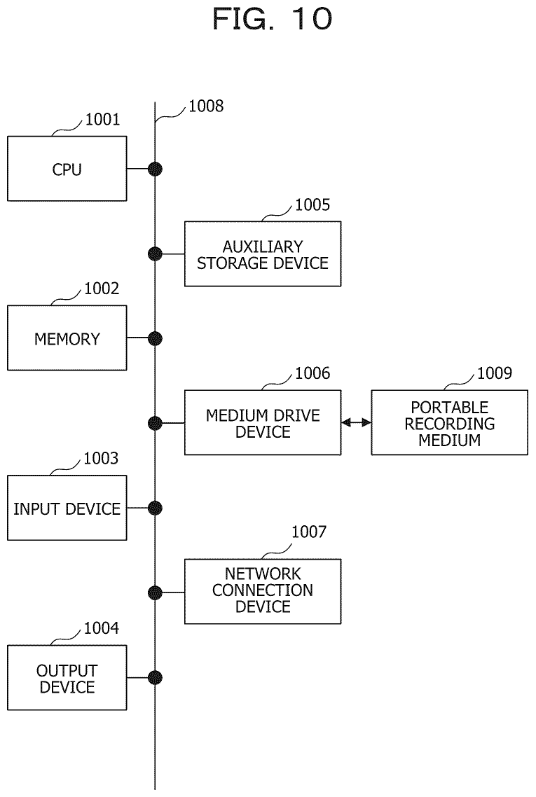

FIG. 10 illustrates a hardware configuration example of an information processing device used as the information processing device 101 in FIG. 1 and the search device 301 in FIG. 3. The information processing device in FIG. 10 includes a central processing unit (CPU) 1001, a memory 1002, an input device 1003, an output device 1004, an auxiliary storage device 1005, a medium drive device 1006, and a network connection device 1007. Those configuration elements are hardware, and are coupled to each other by a bus 1008.

The memory 1002 is, for example, a semiconductor memory such as a read only memory (ROM) or a random access memory (RAM) and stores programs and data to be used for processing.

The memory 1002 may operate as the storage unit 314 in FIG. 3.

The CPU 1001 (processor) operates as the calculation unit 111 and the search unit 112 in FIG. 1 by, for example, executing a program using the memory 1002. The CPU 1001 also operates as the calculation unit 311 and the search unit 312 in FIG. 3 by executing a program using the memory 1002.

For example, the input device 1003 is a keyboard, a pointing device, or the like and is used for inputting instructions or information from a user or an operator. For example, the output device 1004 is a display device, a printer, or the like and is used for an inquiry or an instruction to the user or the operator, and outputting a processing result. The processing result may be the search result 323. The output device 1004 may operate as the output unit 113 in FIG. 1 or the output unit 313 in FIG. 3.

The auxiliary storage device 1005 is, for example, a magnetic disk device, an optical disk device, a magneto-optical disk device, a tape device, or the like. The auxiliary storage device 1005 may be a hard disk drive. The information processing device may store programs and data in the auxiliary storage device 1005 and load these programs and data into the memory 1002 to use. The auxiliary storage device 1005 may operate as the storage unit 314 in FIG. 3.

The medium drive device 1006 drives a portable recording medium 1009 and accesses recorded content of the portable recording medium 1009. The portable recording medium 1009 is a memory device, a flexible disk, an optical disk, a magneto-optical disk, or the like. The portable recording medium 1009 may be a compact disk read only memory (CD-ROM), a digital versatile disk (DVD), a universal serial bus (USB) memory, or the like. The user or the operator may store the programs and data in the portable recording medium 1009 and may use these programs and data by loading the programs and data into the memory 1002.

As described above, a computer-readable recording medium in which the programs and data used for processing are stored is a physical (non-transitory) recording medium such as the memory 1002, the auxiliary storage device 1005, or the portable recording medium 1009.

The network connection device 1007 is a communication interface circuit that is coupled to a communication network such as a wide area network (WAN) or a local area network (LAN) and performs data conversion associated with communication. The information processing device may receive programs and data from an external device via the network connection device 1007 and load these programs and data into the memory 1002 to use. The network connection device 1007 may operate as the output unit 113 in FIG. 1 or the output unit 313 in FIG. 3.

Note that the information processing device does not need to include all the configuration elements in FIG. 10, and some configuration elements may be omitted depending on the use or conditions of the information processing device. For example, in a case where the portable recording medium 1009 or the communication network is not used, the medium drive device 1006 or the network connection device 1007 may be omitted.

While the disclosed embodiment and the advantages thereof have been described in detail, those skilled in the art will be able to make various modifications, additions, and omissions without departing from the scope of the embodiment as explicitly set forth in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
obtaining an estimated value of a risk aversion index for each of a plurality of candidate points in a search space based on a kernel function and an observation history including one or a plurality of observation points and an observed value of a random variable for each of the one or the plurality of observation points;
obtaining a value of an acquisition function for each of the plurality of candidate points based on the estimated value of the risk aversion index;
searching for a target point corresponding to a predetermined value of the acquisition function from among the plurality of candidate points based on the value of the acquisition function; and
outputting a search result including the target point.

2. The non-transitory computer-readable recording medium according to claim 1, wherein the acquisition function includes the risk aversion index and uncertainty of prediction regarding the random variable.

3. The non-transitory computer-readable recording medium according to claim 1, the process further comprising:
selecting a first observation point from among the plurality of candidate points based on the value of the acquisition function;
acquiring the observed value of the random variable for the first observation point;
updating the observation history by adding the first observation point and the observed value of the random variable for the first observation point to the observation history;
obtaining a value of the acquisition function based on the updated observation history;
selecting a second observation point from among the plurality of candidate points based on the value of the acquisition function obtained based on the updated observation history; and
searching for the target point using the second observation point.

4. The non-transitory computer-readable recording medium according to claim 3, wherein the risk aversion index is an index including conditional value-at-risk for the random variable, or an index including an expected value and variance of the random variable.

5. The non-transitory computer-readable recording medium according to claim 1, the process further comprising:
generating a first search space by excluding some of the plurality of candidate points based on the value of the acquisition function;
obtaining a value of the acquisition function based on the first search space;
generating a second search space by excluding some of the plurality of candidate points in the first search space based on the value of the acquisition function obtained based on the first search space; and
searching for the target point from among the plurality of candidate points in the second search space.

6. The non-transitory computer-readable recording medium according to claim 5, wherein the risk aversion index is an index including conditional value-at-risk regarding the random variable.

7. An information processing device, comprising:
a memory; and
a processor coupled to the memory and the processor configured to:
obtain an estimated value of a risk aversion index for each of a plurality of candidate points in a search space based on a kernel function and an observation history including one or a plurality of observation points and an observed value of a random variable for each of the one or the plurality of observation points;
obtain a value of an acquisition function for each of the plurality of candidate points based on the estimated value of the risk aversion index;
search for a target point corresponding to a predetermined value of the acquisition function from among the plurality of candidate points based on the value of the acquisition function; and
output a search result including the target point.

8. The information processing device according to claim 7, wherein the acquisition function includes the risk aversion index and uncertainty of prediction regarding the random variable.

9. The information processing device according to claim 7, wherein
the processor is further configured to:
select a first observation point from among the plurality of candidate points based on the value of the acquisition function;
acquire the observed value of the random variable for the first observation point;
update the observation history by adding the first observation point and the observed value of the random variable for the first observation point to the observation history;
obtain a value of the acquisition function based on the updated observation history;
select a second observation point from among the plurality of candidate points based on the value of the acquisition function obtained based on the updated observation history; and
searching for the target point using the second observation point.

10. The information processing device according to claim 9, wherein the risk aversion index is an index including conditional value-at-risk for the random variable, or an index including an expected value and variance of the random variable.

11. The information processing device according to claim 7, wherein
the processor is further configured to:
generate a first search space by excluding some of the plurality of candidate points based on the value of the acquisition function;
obtain a value of the acquisition function based on the first search space;
generate a second search space by excluding some of the plurality of candidate points in the first search space based on the value of the acquisition function obtained based on the first search space; and
search for the target point from among the plurality of candidate points in the second search space.

12. The information processing device according to claim 11, wherein the risk aversion index is an index including conditional value-at-risk regarding the random variable.

13. An information processing method, comprising:
obtaining, by a computer, an estimated value of a risk aversion index for each of a plurality of candidate points in a search space based on a kernel function and an observation history including one or a plurality of observation points and an observed value of a random variable for each of the one or the plurality of observation points;
obtaining a value of an acquisition function for each of the plurality of candidate points based on the estimated value of the risk aversion index;
searching for a target point corresponding to a predetermined value of the acquisition function from among the plurality of candidate points based on the value of the acquisition function; and
outputting a search result including the target point.

14. The information processing method according to claim 13, wherein the acquisition function includes the risk aversion index and uncertainty of prediction regarding the random variable.

15. The information processing method according to claim 13, further comprising:
selecting a first observation point from among the plurality of candidate points based on the value of the acquisition function;
acquiring the observed value of the random variable for the first observation point;
updating the observation history by adding the first observation point and the observed value of the random variable for the first observation point to the observation history;
obtaining a value of the acquisition function based on the updated observation history;
selecting a second observation point from among the plurality of candidate points based on the value of the acquisition function obtained based on the updated observation history; and
searching for the target point using the second observation point.

16. The information processing method according to claim 15, wherein the risk aversion index is an index including conditional value-at-risk for the random variable, or an index including an expected value and variance of the random variable.

17. The information processing method according to claim 13, further comprising:
generating a first search space by excluding some of the plurality of candidate points based on the value of the acquisition function;
obtaining a value of the acquisition function based on the first search space;
generating a second search space by excluding some of the plurality of candidate points in the first search space based on the value of the acquisition function obtained based on the first search space; and
searching for the target point from among the plurality of candidate points in the second search space.

18. The information processing method according to claim 17, wherein the risk aversion index is an index including conditional value-at-risk regarding the random variable.
